(19) United States
(12) Patent Application Publication
(10) Pub. No.: US 2017/0042184 A1
(43) Pub. Date: Feb. 16, 2017

(54) LIQUID COMPOSITION FOR FROZEN CONFECTION, METHODS OF PRODUCTION AND PREPARATION

(71) Applicant: NESTEC S.A., Vevey (CH)

(72) Inventors: Paola Olmos, Meriel (FR); Charles-Austin Sunderland, Laversines (FR); Emmanuelle Florentin, Hotot en Auge (FR); Andre North, Pully (CH)

(21) Appl. No.: 15/305,857

(22) PCT Filed: May 6, 2015
(86) PCT No.: PCT/EP2015/060000

§ 371 Date: Oct. 21, 2016

(30) Foreign Application Priority Data
May 7, 2014 (EP) 14167323.6

(51) Int. Cl. A23G 9/52; A23G 9/32; A23G 9/46; A23L 3/16; A23G 9/34; A23G 9/40

(52) U.S. Cl. CPC A23G 9/52; A23G 9/34; A23G 9/40; A23G 9/46; A23L 3/16; A23G 9/327; A23V 2002/00

(57) ABSTRACT

The present invention relates a liquid composition for frozen confection, in particular to a shelf stable composition which is suitable for making freshly prepared frozen confection. The liquid composition for frozen confection comprising below 4.5 % wt of fat by weight based on the total composition (wt), below 15 wt of sweetener, 0.01 to 3% wt of stabilizers, optionally yogurt, and having a freezing point from 0° C. to −3° C., preferably from −1° C. to −2.2° C., and a solid content above 20% wt. The invention also relates to a method of production of the liquid composition and to a method of preparation of the frozen composition.

### FIELD OF THE INVENTION

The present invention relates a liquid composition for frozen confection, in particular to a shelf stable composition which is suitable for making freshly prepared frozen confection. The invention also relates to a method of production of the liquid composition and to a method of preparation of the frozen composition.

### BACKGROUND

Currently, the majority of ice cream consumption at home concerns products bought frozen at the point of sales. There are several drawbacks such as the need to transport the products at home rapidly in order to keep them at the frozen state, the need to store them in a freezer and the limited number of flavors available considering standard freezer volume. Additionally, the texture of such product is rather hard and far from the freshly made ice cream.

An alternative solution available today is the use of an ice cream machine to produce fresh ice cream. Although the obtained texture of the resulting product is more satisfactory the products can be made to have better texture nevertheless drawback exists in term of such products' nutritional profile e.g. high sugar or high fat content in the product compositions.

Hardened ice creams or frozen yogurts from industrial manufacture and are made from dairy based mixes which have crystallized texture and cold mouth feel after cold chain temperature fluctuations. These products do not have the creamy sensation of a freshly prepared ice cream which some consumers prefer. This effect is even more pronounced for low fat products.

Sterilised ambient mixes for ice cream are available for artisanal Gelaterias. These products are high on fat and/or sugar content to obtain creamy soft products.

In addition to the above consumers' demand continuously increases for “better for you” types of products with lower fat contents or even non-fat products, while not compromising on taste. Compositional changes aimed at reducing calories must be however also be efficient in terms of their impact on the freezing point and the dynamics of freezing and thawing

In view of the previous discussion, there is therefore a need to find solution to provide shelf stable liquid compositions for freshly prepared ice cream which provides good texture and taste and a good nutritional profile.

### Object of the invention

It is thus the object of the present invention is to provide liquid composition for preparation of frozen confection, in particular for freshly made frozen confection, which has a creamy texture and which has a good nutritional profile.

### SUMMARY OF THE INVENTION

It was surprisingly found that a liquid dairy composition for preparation of a frozen confection can be made containing low fat and low sugars and using natural stabilization. It has also been found that when freezing the liquid composition while stirring it is possible to obtain a creamy texture that compares to indulgent full fat and high sugar products.

Accordingly, the present invention relates to a liquid composition for frozen confection comprising
below 4.5% wt of fat by weight based on the total composition (wt)
below 15% wt of sweetener
0.01 to 3% wt of stabilizers
optionally yogurt, and

having a freezing point from 0° C. to −3° C. and a solid content above 20% wt.

In particular the invention relates to a composition which has been found to have very good freezing properties for the process according to the invention in terms of fast freezing while providing a soft texture. This is unexpected because product formulations with high freezing points are expected to provide hard texture. Nevertheless, the composition according to the invention provides a soft texture. Advantageously, composition has a freezing point from −1° C. to −2.2° C. resulting from the low fat and low sugar in the composition and which has been found to provide a fast freezing process.

In particular the invention relates to a liquid composition which has been subjected to ultra-high temperature treatment, and which is shelf stable. It has surprisingly been found that the UHT treatment on such liquid composition a positive effect on texture of the product was obtained.

A particular advantage of the invention is that it allows the making of a frozen confection with improved sensorial properties of low fat and low sugars formulations, for example when the fat content of the product is below 4% wt. Even a fat content below 2% fat this advantage is detected for the creamy texture, the increased mouth coating and body similar to full fat products. When the product contains low sugar, such as below 10% wt of added sugars or even below 7% wt the advantage is that even with the modification of freezing point, the use of the high velocity stirring means allow to obtain soft textures similar to classical ice creams but without the inconvenience of the level of sugars for the health as the classical products.

In a further aspect, the invention relates to a method of production a liquid frozen confection product, comprising the steps of:
a) providing an liquid composition according to any of claims 1 to 6,
b) homogenizing the composition,
c) pasteurizing the composition at a temperature of at least 90° C., preferably at least 130° C. for a period of at least 30 sec and
d) packing the liquid composition.

This process is particular suitable for ice cream.

In an additional aspect, the invention relates to a method of production a shelf stable liquid confection for preparation of frozen product, comprising the steps of:
a) providing an liquid composition according to claims 7 and 8,
b) homogenizing the composition,
c) heating the composition at a temperature of at least 94° C. for at least 180 seconds, and
d) packing the liquid composition.

This process is particular suitable for frozen yoghurt.

In another aspect, the invention relates to a process for preparation of a frozen confection, comprising the steps of
a) providing a liquid composition according to claims 1 to 12,
b) freezing the liquid composition by cooling it for a period below 10 minutes to a temperature below 0° C., preferably to a temperature in the range from −2 to −10° C., and at the same time
c) aerating the liquid composition to an overrun in the range from 30% to 120% by stirring the composition.

### BRIEF DESCRIPTION OF THE FIGURE

FIG. 1 shows images of crystal shapes in shelf-stable product frozen with a conventional ice cream maker and a shelf-stable product frozen in accordance with the process of the invention.

FIG. 2 shows a product according to the invention.

### DETAILED DESCRIPTION OF THE INVENTION

According to the present invention a liquid composition is provided which provides a frozen confectionery product which contains below 4.5% fat while as still taste as indulgent as full fat ice cream.

By a shelf stable is meant products that do not spoil under ordinary unrefrigerated temperature and humidity conditions, if the package integrity is maintained. These products are free of microorganisms capable of growing in or on the product at non-refrigerated conditions at which the product is held during distribution and storage Food Safety and Inspection Service—United States Department of Agriculture (FSIS USDA 2005).

In the present context ultra-high temperature treatment (UHT) is temperature treatment wherein the product is subjected strong heating for a short time. For the present invention it is preferred that the liquid product is subjected to a heat treatment with a temperature of at least 90° C., preferably at least 130° C. for a period of at least 30 sec. A preferred time of treatment is from 30 sec to 3 min. The invention also relates to a liquid product which has been heat treated at a temperature in the range from 90° C. to 160° C.

A determination of the freezing point can be based on freezing point depression of a formulation which is well known to a person skilled ice cream making. In the present context the freezing point can be calculated based the ice cream handbook “Ice Cream” by H. Douglass Goff, 7th edition, page 181 “calculation of freezing point depression of a mix”.

Further in the present context unless otherwise indicated % of a component means the % of weight based on the weight of the creamer composition, i.e. weight/weight %.

Further in the present context unless otherwise indicated the ranges indicated in this application includes the end points.

The liquid composition according to the invention comprises 0.01 to 3% wt of stabilizers. The stabilizers are preferably hydrocolloids, in particular hydrocolloids selected from the group consisting of guar gum, locus bean gum, pectine, fibers or combinations thereof

In the present context stabilizers can be emulsifiers or hydrocolloids. An emulsifier is a substance that stabilizes an emulsion by increasing its kinetic stability. A hydrocolloid is defined as a colloid system wherein the colloid particles are hydrophilic polymers dispersed in water. A hydrocolloid has colloid particles spread throughout water, and depending on the quantity of water available that can take place in different states, e.g., gel or sol (liquid).

Depending of the amount and pH of the yogurt in the liquid product it may be necessary to adjust the pH to the ranges indicated above. Thus in an embodiment of the invention the liquid product comprises a pH adjusting agent. The pH adjusting agent may for example be molasses, an edible organic acid such as citric acid, acetic acid, lactic acid, malic acid, ascorbic acid, benzoic acid, fumaric acid, lactones such as glucono-delta-lactone, fruit derived acids and fermentation derived acids. In a preferred embodiment of the invention, the liquid product comprises a pH adjusting agent which is citric acid or lemon juice.

According to a specific embodiment of the invention, the product essentially consists of natural ingredients.

The term “essentially consist” means that at least 95% of the ingredients have to be natural, such as at least 97%, preferably at least 98%, even more preferably at least 99%.

The term “natural ingredients” refer in the context of the present invention to ingredients of natural origin. These include ingredients which come directly from the field, animals, etc. or which are the result of a physical or microbiological/enzymatic transformation process. These therefore do not include ingredients which are the result of a chemical modification process.

In another embodiment of the invention, the product is essentially or completely free of any artificial or non-natural emulsifier or stabilizer.

Examples of artificial and non-natural ingredients which are avoided in a particular embodiment of the invention include for example the following emulsifiers; mono- and diglyceride of fatty acids, acid esters of mono- and diglycerides of fatty acids such as acetic, lactic, citric, tartaric, mono- and diacetyl tartaric acid esters of mono- and diglycerides of fatty acids, mixed acetic and tartaric acid esters of mono- and diglycerides of fatty acid, sucrose esters of fatty acids, polyglycerol esters if fatty acids, polyglycerol polyricinoleate, polyethylene sorbitan mono-oleate, polysorbate 80 and, chemically extracted lecithins.

The term “artificial emulsifiers” may also be referred to as synthetic emulsifiers or non-natural emulsifiers and the terms may be used interchangeably.

Chemically modified starches which are used in the art as stabilizers are also preferably avoided. These include for example modified starch, monostarch phosphate, distarch phosphate, phosphate or acetylated distarch phosphate, acetylated starch, acetylated distarch afipate, hydroxyl propyl starch, hydroxypropyl distarch phosphate, acetylated modified starch.

The products of the present invention are preferably essentially free of the preceding synthetic esters and modified starches.

“Essentially free” means in the context of the present application, that these material are not intentionally added for their conventional property imparting abilities, e.g. stabilizing, although there could be unintended minor amounts present without detracting from the performance of the products. Generally and preferably, the products of the invention will not contain any non-natural materials. By the term “essentially or completely free” is therefore meant that the product comprise 1% by weight or less of a given compound.

In another embodiment of the invention, the frozen confection product is a low-fat product and comprises at most 2% fat by weight.

In the context of the present invention, the term “fat” should be interpreted broadly and generally relates to one or more triglycerides independent of their melting temperature. The term “fat” comprises both triglycerides that are in liquid form at 25° C., as well as triglycerides that are in solid or semi-solid form at 25° C. Fatty acid triesters of the trihydroxy alcohol glycerol which are present in plant and animal tissues that can occur both as liquid or semi-liquid or solid fat forms. The physical and chemical properties of fats and oils depend on the nature of the fatty acids present. Saturated fatty acids give higher melting fats and represent solid fats, for example lard and butter. Unsaturated fats lower the melting point of fatty acids and fats, e.g. plant oils contain large amounts of unsaturated fatty acids.

The liquid composition of the present invention may further include one or more additional ingredients such as flavors, sweeteners, colorants, acids, setting salts, buffer salts or a combination thereof.

According to the invention the liquid composition comprises 10 to 15% sweetener.

Sweeteners can include, for example, sucrose, fructose, dextrose, maltose, dextrin, levulose, tagatose, galactose, corn syrup solids and other natural or artificial sweeteners. Sugarless sweeteners can include, but are not limited to, sugar alcohols such as maltitol, xylitol, sorbitol, erythritol, mannitol, isomalt, lactitol, hydrogenated starch hydrolysates, and the like, alone or in combination. Usage level of the flavors, sweeteners and colorants will vary greatly and will depend on such factors as potency of the sweetener, desired sweetness of the product, level and type of flavor used and cost considerations. Combinations of sugar and/or sugarless sweeteners may be used.

Preferably the sweetener is carbohydrates and the total carbohydrates content is comprised from below 15%, preferably from 1 to 15, more preferably from 9 to 14 wt. -% based on the total composition.

Advantageously, the sweetener is sucrose or glucose syrup or a combination thereof In a further preferred embodiment of the invention, the sweetener consists of 8% wt white sugar and optionally 8% wt glucose syrup.

In a preferred embodiment the total solids content is between 10 to 40%, preferably from 12 to 30%, more preferably 15 to 24% based on the weight of the total composition. This give a good texture to the product, with lower solid content the product becomes icy and hard in consistency.

In one embodiment of the invention the liquid composition is for providing an ice cream product. In this embodiment the liquid composition is pasteurized.

In another embodiment of the invention the liquid composition is for providing a frozen yoghurt. In this embodiment the liquid composition comprises liquid comprises at least 30% yoghurt, preferably at least 45% yoghurt. The frozen yoghurt according to the invention is preferably subjected to a heat treatment a temperature treatment with a temperature in the range from 90° C. to 160° C.

The liquid composition may be packed in a container, preferably in a portion size for individual servings.

The liquid composition for making an ice cream according to the invention is preferably produced by a method comprising the steps of:
a) providing an liquid composition according to any of claims 1 to 6,
b) homogenizing the composition,
c) pasteurizing the composition at a temperature of at least 90° C., preferably at least 130° C. for a period of at least 30 sec and
d) packing the liquid composition.

The composition is then shelf stable due to the heat treatment.

The liquid composition for making a frozen yoghurt according to the invention is preferably produced by a method comprising the steps of
a) providing an liquid composition according to claims 7 and 8,
b) homogenizing the composition,
c) heating the composition at a temperature of at least 94° C. for at least 180 seconds when the recipe contains yogurt.
d) packing the liquid composition.

The composition is then shelf stable due to the heat treatment.

The liquid composition may be packed into a container which is preferably a single-use container which provides an initial packaging container for a predefined amount of ingredients. The packaging container preferably contains confectionery ingredients which are stored under ambient conditions and shelf stable for an extensive period of time (e.g., several weeks). Further, the container is also designed for being used as process container, i.e. as container in which the frozen confectionary is prepared, as well as serving container, i.e. as container from which the consumer may directly consume the resulting frozen confectionary. Preferably, the packaging container comprises an identification means containing a recipe code related to the type of cooled product to be prepared. In the preferred mode, the identification means comprises at least one barcode.

The term “single-use container” when used in the present invention encompasses any container suitable for being disposed after being used for the preparation of the single-portion of cooled product. Thereby, the containers are preferably at least partially recyclable.

In one aspect the invention also relates to a process for preparation of a frozen confection, comprising the steps of
a) providing a liquid composition according to the invention as discussed above,
b) freezing the liquid composition by cooling it for a period below 10 minutes to a temperature below 0° C., preferably between −2.5 and −5° C., and at the same time
c) aerating the liquid composition to an overrun of 30% to 120% by stirring the composition.

A desirable creamy product texture is obtained when the freezing of the product is to a temperature from in the range from −2° C. to −6° C., and an aeration to an overrun in the range from 70% to 110%.

Preferably for this embodiment of the invention the frozen confection is prepared in its container. For this purpose a container is having a heat exchange contact surface through which the product is cooled may conveniently be used. This allows for a quick freezing of the liquid composition when the container is brought into contact with cooling means during the aeration.

The freezing may be done by means of a conventional domestic ice cream maker. Alternatively and preferably the liquid composition may be prepared by in a machine for preparing frozen confection as disclosed in co-pending patent applications:

European patent application number 12190562.4 filed on 30 Oct. 2012;

European patent application number 13190868.3 filed 30 Oct. 2013; and European patent application number 13190834.5 filed on 30 Oct. 2013.

The contents of these applications are hereby incorporated by reference.

In a preferred process for preparation of a frozen confection according the invention the aerating is done by means of a stirring member and by contacting the composition during freezing with the stirring member
which stirring means has a planetary movement with an angular velocity ω2 between 30 and 300 rpm and/or a rotation about an axis with an angular velocity ω1 of 1 to 1700 rpm, preferably between 400 and 900 rpm.

Advantagesly, the process mentioned above may be performed in a machine for preparing a cooled food product as disclosed in European patent application number 13190868.3 filed 30 Oct. 2013. This machine comprising:
a receiving seat, for accommodating a container, comprising a heat exchange element having a heat exchange contact surface arranged to be in contact with an outer surface of a side wall of the container when the container is placed in the machine,
a cooling unit arranged for cooling the heat exchange element and,
a stirring unit connectable to a stirring member and arranged for driving the stirring member in at least one rotational movement;

wherein it comprises
means for measuring the temperature of the product while being prepared,
a control unit for automatically setting output parameters according to input parameters received by the control unit and compared to threshold values stored in the unit;
wherein the output parameters comprises: at least one rotational velocity of the stirring member and the cooling power of the cooling unit, and
wherein the input parameters comprises any one or a combination of: the measured product temperature and the stirring time.

The machine preferably has a stirring unit being arranged for driving the stirring member according to a combination of movements, wherein the combination of movement comprises a first rotational movement of the stirring member about its longitudinal axis (Z) which is arranged offset to a central longitudinal axis (X) of the receiving seat (1) and/or of the container and wherein the second rotational movement comprises an orbital rotational movement about the central longitudinal axis (X) of the container or seat (1) and wherein the output parameters comprise the first velocity (ω1) of the first rotational movement and the second velocity (ω2) of the second rotational movement of the stirring member. A machine of the above-mentioned type was used in the examples.

### EXAMPLES

By way of example and not limitation, the following examples are illustrative of various embodiments of the present disclosure.

Low Fat Dairy Based Frozen Confection with Similar Mouth Feel to that of Full Fat Ice Cream

### Example 1

A dairy base shelf-stable confectionery product was prepared based on the following ingredient mix:

| Ingredients | Wt % of final product |
|---|---|
| Fat | 4 |
| Added Sugar | 13 |
| Milk Solids No Fat (MSNF) | 3.5 |
| Stabilizers: guar, LBG | 0.30 |
| Total solids | 32 |
| FPD (freezing point depression) | −1.94 |
| pH mix before heat treatment | 6.6 |

Process Conditions

1. Mixing Conditions

All ingredients were mixed at 65° C. and then treated by sterilization as follows:

| Step | Sterilization |
|---|---|
| Heat treatment | heat plate exchanger at |
| | 130° C. 30 sec |
| Homogenization | 2 step high pressure |
| | homogenizer at 150 and 50 |
| | bar |
| Aging | 24 h at 4° C. |

1. Freezing Conditions

Aged mix was frozen using a the above described machine at −6° C. and a commercially available machine to make ice cream at home, also at the same temperature.

Results

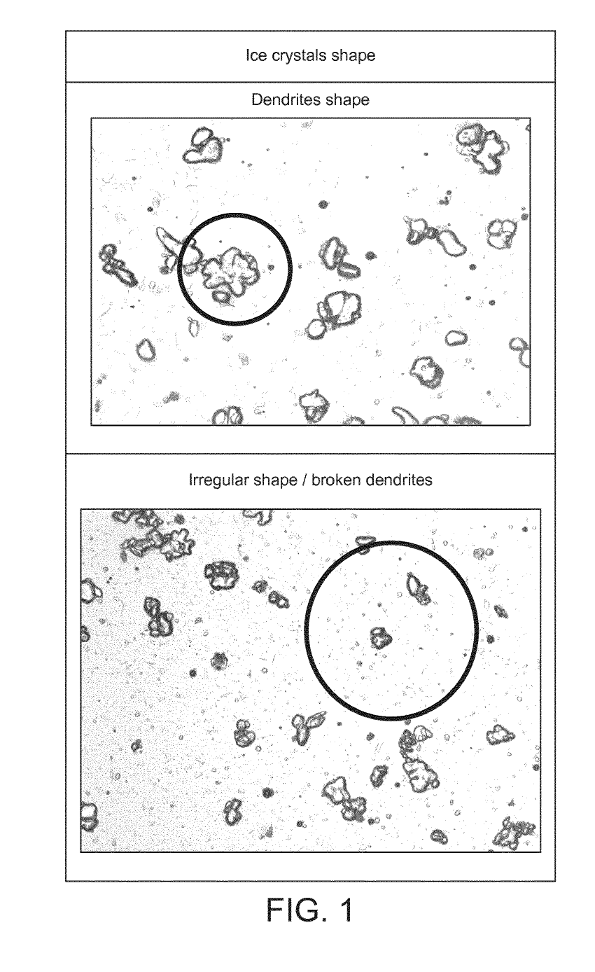

The sterilized low fat dairy base shelf-stable confectionery product when frozen with a machine as described above surprisingly delivered a novel texture extra creamy. The resulting products are shown in FIG. 1.

| Sample | Overrun | Ice crystals shape | Texture |
|---|---|---|---|
| Dairy based shelf-stable | 40% | Dendrites shape | Less smooth |
| composition frozen with | | | |
| commercially available | | | |
| gelateria for home use | | | |
| (Megamix Gelato 2000) | | | |
| Dairy based shelf-stable | 100% | Irregular | Very creamy, |
| composition frozen with the | | shape/broken | increased |
| machine | | dendrites | mouth coating |
| | | | and body |

### Example 2

Shelf-Stable Confection to Prepare Fresh Made High Quality Frozen Yogurt Using Home Machine

A dairy based shelf-stable confectionery product comprising yogurt, stabilizing system and sugars was prepared based on the following ingredient mix:

| Ingredients | Wt % of final product |
|---|---|
| Fresh yogurt from lactic acid bacteria fermentation | 50 |
| Fat (dairy or vegetable fat + emulsifiers) | 3 |
| Added Sugar | 11.8 |
| Proteins | 3.5 |
| Stabilizers: pectine | 0.75 |
| Optional Stabilizers: guar, LBG, fibers | 3 |
| Total solids | 27 |
| FPD (freezing point depression) | −1.62 |
| pH mix before heat treatment | <4.2 |

Process Conditions

1. Mixing Conditions

All ingredients were mixed at 65° C. for 20 min, the pH of the mix was adjusted in order to be less than 4.2. Then the mix was pasteurized as follows:

| Step | Pasteurization |
|---|---|
| Heat treatment | heat plate exchanger at 94° C. 180 |
| | sec |
| Homogenization | 2 step high pressure |
| | homogenizer at 150 and 50 bar |
| Aging | 24 h at 4° C. |

The mix is optionally aseptically packed.

2. Freezing Conditions

The shelf-stable mix was frozen with the machine at −6° C.

Results

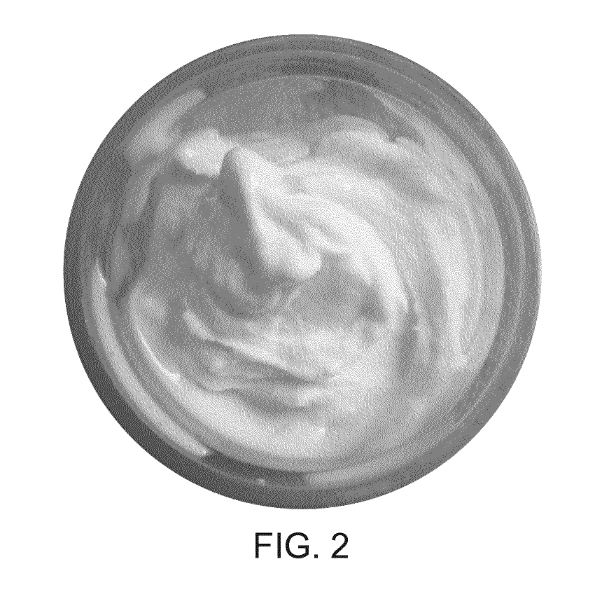

The shelf-stable confectionery product when frozen with home machine delivered a high quality frozen yogurt, smoother and creamier than industrial hardened frozen yogurt or artisanal frozen yogurt. The overrun of the preparation was 45% depending of home machine parameters. Picture of the obtained frozen yogurt is shown on FIG. 2.

### Example 3

Process

Pour 70 g to 90 g of prepared mix that has been stored at chilled (+4° C.) or ambient temperature (20° C.) into a cup with a volume between 150 ml to 250 ml.

To maximise heat transfer through the cup it is preferable that it should be, at least in part, metallic for example aluminium. The cup is placed into the preparation system so that its sides are in contact with the cooling surface.

A stirrer is then inserted into the preparation system. The form of the stirrer is adapted to incorporate air into the product and to move colder product from the cups walls that are in contact with the cooling surface towards the centre of the cup to better equalise product temperature. For example it could be a whisk type. In this example it is more spatula like with a form that follows the contours of the cup.

Traditional kitchen bench top ice cream machines use stirrers that turn speeds ranging from 28 rpm to 72 rpm generally around a single central axis.

The stirring action has in this example two mixing axis, one around the axis of the stirrer its self and the second a planetary movement that permits the stirrer to move through the entire contents of the cup. The planetary movement and that of the stirrer can be in either a clockwise or anticlockwise direction. The speed of the planetary movement can vary between 30 to 300 rpm and the stirrer turns on its axis in at speeds from 1 to 1700 rpm. In this example the planetary movement is 60 rpm in a clockwise direction and the stirrer turns on its axis at 800 rpm in a clockwise direction

In the preparation system the mixture described in the examples 1 and 2 above is cooled and stirred. The stirring action incorporates air into the mixture as it cools. The liquid product is transformed into frozen dessert such as an ice cream type product at a temperature below 0° C. preferably between −2° C. to −6° C. As mixing time increases more air is incorporated into the preparation to give products with an overrun from 40% to over 100%. In this example at the end of mixing the product has 87% over run and a temperature of −4.7° C.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A liquid composition for frozen confection comprising:
less than 4.5% wt of fat by weight based on the total composition (wt);
less than 15% wt of sweetener;
0.01 to 3% wt of stabilizers; and
having a freezing point from 0° C. to −3° C. and a solid content above 20% wt.

2. A liquid composition according to claim 1, having a freezing point from −1° C. to −2.2° C.

3. A liquid composition according to claim 1, wherein the fat content is less than 2% wt.

4. A liquid composition according to claim 1, wherein the pH of the liquid composition is less than 4.2.

5. A liquid composition according to claim 1, having total solids content between 20 to 40% based on the weight of the total composition.

6. A liquid composition according to claim 1, wherein the sweetener is a carbohydrate and the total carbohydrates content is less than 15% wt based on the total composition

7. A liquid composition according to claim 1, wherein the liquid composition is pasteurized.

8. A liquid composition according to claim 1, wherein the liquid comprises at least 30% yoghurt.

9. A liquid composition according to claim 7, wherein the liquid composition has been subjected to a temperature treatment with a temperature in the range from 90° C. to 160° C.

10. A liquid composition according to claim 1, wherein the composition is packed in a container.

11. A method of production a shelf stable liquid confection for preparation of frozen product, comprising the steps of:
a) providing a liquid composition for frozen confection comprising: less than 4.5% wt of fat by weight based on the total composition (wt); less than 15% wt of sweetener; 0.01 to 3% wt of stabilizers; and having a freezing point from 0° C. to −3° C. and a solid content above 20% wt;
b) homogenizing the composition;
c) pasteurizing the composition at a temperature of at least 90° C. for a period of at least 30 sec; and
d) packing the liquid composition.

12. A method of production a shelf stable liquid confection for preparation of frozen product, comprising the steps of:
a) providing a liquid composition, for frozen confection comprising: less than 4.5% wt of fat by weight based on the total composition (wt); less than 15% wt of sweetener; 0.01 to 3% wt of stabilizers; and having a freezing point from 0° C. to −3° C. and a solid content above 20% wt;
b) homogenizing the composition;
c) heating the composition at a temperature of at least 94° C. for at least 180 seconds; and
d) packing the liquid composition.

13. A process for preparation of a frozen confection, comprising the steps of:
a) providing a liquid composition for frozen confection comprising: less than 4.5% wt of fat by weight based on the total composition (wt); less than 15% wt of sweetener; 0.01 to 3% wt of stabilizers; and having a freezing point from 0° C. to −3° C. and a solid content above 20% wt;
b) freezing the liquid composition by cooling it for a period below 10 minutes to a temperature below 0° C. and at the same time
c) aerating the liquid composition to an overrun in the range from 30% to 120% by stirring the composition.

14. A process for preparation of a frozen confection according to claim 13, wherein the freezing of the product is to a temperature from in the range from −2° C. to −6° C., and an aeration to an overrun in the range from 70% to 110%.

15. A process for preparation of a frozen confection according to claim 13, wherein the aerating is done by means of a stirring member and by contacting the composition during freezing with the stirring member;
which stirring means has a planetary movement with an angular velocity ω2 between 30 and 300 rpm; and/or
a rotation about an axis with an angular velocity ω1 of 1 to 1700 rpm, preferably between 400 and 900 rpm.

16. A process for preparation of a frozen confection according to claim 13, wherein the product is prepared in its container.

17. A process for preparation of a frozen confection according to claim 16, wherein the container is having a heat exchange contact surface through which the product is cooled.
